(19) United States
(12) Patent Application Publication
(10) Pub. No.: US 2018/0029789 A1
(43) Pub. Date: Feb. 1, 2018

(54) Tea Bag with Accessible Opening

(71) Applicants: Po Chun Yip, Tsuenwan (HK); Anthony Paul Priley, Sacramento, CA (US); Robert Felipe, Miami, FL (US)

(72) Inventors: Po Chun Yip, Tsuenwan (HK); Anthony Paul Priley, Sacramento, CA (US); Robert Felipe, Miami, FL (US)

(73) Assignee: (PBS) Professional Beauty Supply, Ltd., Hong Kong (HK)

(21) Appl. No.: 15/222,153

(22) Filed: Jul. 28, 2016

(51) Int. Cl. B65D 85/808; B65D 30/00; A47J 31/40; B65D 85/804

(52) U.S. Cl. CPC B65D 85/808; B65D 85/8046; B65D 29/00; A47J 31/407

(57) ABSTRACT

A porous bag for brewing a brewable substance held therein, includes an enclosure bag including walls made from a porous material, with the brewable substance held in the enclosure bag; and an accessible opening in one wall of the enclosure bag for receiving a liquid supply tube therein for supplying liquid to the enclosure bag, the accessible opening preventing the brewable substance from escaping so that the porous bag can be used as a steeping bag in a liquid, while also permitting access to the opening to permit supply of the liquid therein from the liquid supply tube inserted therethrough.

### BACKGROUND OF THE INVENTION

The present invention relates generally to tea bags which can be used in brewable beverage making machines or the like of the type which includes a tube which serves to puncture a container having a brewable substance therein and then supply pressurized water to the container.

Conventionally, tea bags are made of a porous material containing loose tea leaves or other brewable substances, which are intended to be sold with an overwrap packaging which is torn and discarded, to remove the tea bag. The tea bag is then supplied to a body of water for steeping purposes, and then discarded. However, such tea bags are not susceptible to being used in a brewing machine.

It is also known to provide a single serve coffee brewing machine sold under the registered trademark KEURIG, which has become very popular. This machine uses a single portion cartridge or packet sold under the registered trademark K-CUP. Each packet includes a cup packed with a brewing material, such as coffee, and sealed air tight at its upper open end with a foil lid. A similar machine is sold under the trademark NESPRESSO.

When the packet is placed in one of its brewing machines, the brewer punctures the foil lid with a spray nozzle and the bottom wall of the packet with a discharge nozzle. Coffee grounds or tea are held in the packet. Hot water under pressure is supplied through the spray nozzle, mixes with the coffee grounds or tea, and then exits through the discharge nozzle to a mug positioned by the user below the discharge nozzle.

The applicant herein filed U.S. patent application Ser. No. 14/140,189 on Dec. 24, 2013 for a BREWABLE BEVERAGE MAKING CUP ADAPTOR FOR CARTRIDGE TYPE COFFEE MAKING MACHINES AND CARTRIDGE TYPE COFFEE MAKING MACHINE. In this invention, a tube in the adapter supplies pressurized water that is forced into the tea leaves to better extract the flavor from the tea leaves by creating agitation and turbulence of the hot water entering the adapter.

However, this arrangement requires a special cup adapter to brew the tea leaves.

However, such K-CUPs or cup adapters are not susceptible to being used as a conventional tea bag because the outer walls are not porous.

It is therefore desirable to provide a tea bag that can be used as a conventional tea bag as well as being used in a brewing machine.

### SUMMARY OF THE INVENTION

Accordingly, it is an object of the present invention to provide a tea bag with an accessible opening that overcomes the aforementioned problems.

It is another object of the present invention to provide a tea bag with an accessible opening that can be used as a conventional tea bag.

It is still another object of the present invention to provide a tea bag with an accessible opening in which the opening can be punctured or otherwise made accessible to receive a tube that supplies pressurized water to the tea bag.

It is yet another object of the present invention to provide a tea bag with an accessible opening in which the accessible opening is reinforced to prevent tearing of the tea bag surrounding the opening.

It is a further object of the present invention to provide a tea bag with an accessible opening in which the accessible opening includes tabs which hold the tube after accessing the opening and prevent the tube from piercing the opposite side of the tea bag.

It is a still further object of the present invention to provide a tea bag with an accessible opening that is easy and economical to make and use.

In accordance with an aspect of the present invention, a porous bag for brewing a brewable substance held therein, includes an enclosure bag including walls made from a porous material, with the brewable substance held in the enclosure bag; and an accessible opening in one wall of the enclosure bag for receiving a liquid supply tube therein for supplying liquid to the enclosure bag, the accessible opening preventing the brewable substance from escaping so that the porous bag can be used as a steeping bag in a liquid, while also permitting access to the opening to permit supply of the liquid therein from the liquid supply tube inserted therethrough.

Preferably, the accessible opening includes at least one score line in the one wall. In such case, a reinforcing arrangement is provided around the accessible opening for preventing tearing of the one wall in an area surrounding the accessible opening when the score lines are torn.

The at least one score line divides the accessible opening into a plurality of tabs which are connected at a periphery of the accessible opening, and which are connected to each other by a plurality of score lines. The tabs preferably each have a triangular configuration.

In one modification, the at least one score line includes a circumferential score line adapted to be torn to remove the material of the one wall within the circumferential score line to expose the accessible opening.

In another modification, the at least one score line includes at least one set of parallel score lines adapted to be torn to remove the material of the one wall between each set of parallel score lines, to expose the accessible opening.

Further, the at least one score line is adapted to be torn by piercing.

In another embodiment, the accessible opening is formed of a material that is more rigid than the porous material of the walls of the bag. For example, the enclosure bag includes a top wall of a material that is more rigid than the porous material of the walls of the bag, and the accessible opening is formed in the top wall.

A string having one end is preferably attached to at least one wall.

In another embodiment, a covering is secured to the one wall in covering relation to the accessible opening which prevents the brewable substance from escaping so that the porous bag can be used as a steeping bag in a liquid, while also permitting access to the accessible opening to permit supply of the liquid therein from the liquid supply tube inserted therethrough.

The covering preferably includes at least one score line in the one wall.

In one embodiment, the at least one score line divides the covering into a plurality of tabs which are connected at a periphery of the covering, and which are connected to each other by a plurality of score lines. The tabs preferably each have a triangular configuration.

In another modification, the at least one score line includes a circumferential score line adapted to be torn to remove material of the covering within the circumferential score line to expose the accessible opening.

In a further modification, the at least one score line includes at least one set of parallel score lines adapted to be torn to remove material of the covering between each set of parallel score lines, to expose the accessible opening.

Preferably, the covering is formed of a material that is more rigid than the porous material of the walls of the bag.

In accordance with another aspect the invention, a covering is removably secured to the one wall in covering relation to the accessible opening.

In a further embodiment, the tea bag includes a frusto-conical side wall for fitting within a frusto-conical cup adapter of similar dimensions for brewing.

The above and other features of the invention will become readily apparent from the following detailed description thereof which is to be read in connection with the accompanying drawings.

### BRIEF DESCRIPTION OF THE DRAWINGS

FIG. 1 is a perspective view of a tea bag according to a first embodiment of the present invention;

FIG. 2 is a front elevational view of the tea bag;

FIG. 3 is a front elevational view of the tea bag being penetrated by a water supply tube;

FIG. 4 is an enlarged view of the tea bag and water supply tube of FIG. 3;

FIG. 5 is a perspective view of a portion of a tea bag according to a modification of the first embodiment of the present invention;

FIG. 6 is a perspective view of a portion of a tea bag of FIG. 5, with the opening pierced by the piercing tube;

FIG. 7 is a perspective view of a tea bag according to a second embodiment of the present invention;

FIG. 8 is a perspective view of the tea bag of FIG. 7, with the opening initially pierced by the piercing tube;

FIG. 9 is a perspective view of the tea bag of FIG. 7, with the opening fully pierced by the piercing tube;

FIG. 10 is an enlarged perspective view of a portion of FIG. 9, showing the tea bag pierced by the piercing tube;

FIG. 11 is an enlarged perspective view of a portion of FIG. 10, showing the tea bag pierced by the piercing tube;

FIG. 12 is a perspective view of a tea bag according to a third embodiment of the present invention;

FIG. 13 is a perspective view of the tea bag according to a modification of the third first embodiment of the present invention;

FIG. 14 is a perspective view of a tea bag according to a fourth embodiment of the present invention, in a collapsed state;

FIG. 15 is a perspective view of the tea bag of FIG. 14 in an expanded cylindrical shape;

FIG. 16 is a perspective view showing the tea bag of FIG. 15 being inserted in a brewable beverage making cup adaptor for a cartridge type coffee making machine; and

FIG. 17 is a perspective view showing the tea bag of FIG. 15 fully inserted in the brewable beverage making cup adaptor for the cartridge type coffee making machine.

### DETAILED DESCRIPTION

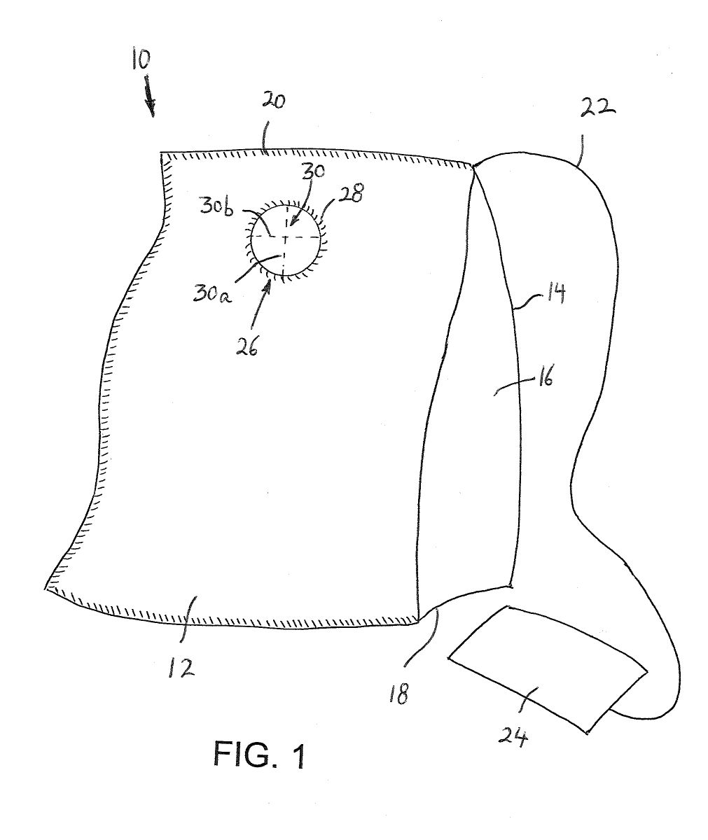

Referring to the drawings in detail, and initially to FIGS. 1-4, a tea bag 10 according to a first embodiment of the present invention, is shown. Tea bag 10 is constructed as a conventional tea bag, with a front wall 12, rear wall 14, interconnecting triangular side walls 16 and a bottom wall 18. Thus, the upper edges of front wall 12 and rear wall 14 are connected together, the side edges of front wall 12 and rear wall 14 are connected to respective side edges of triangular side walls 16, and bottom wall 18 is connected to the lower edges of front wall 12, rear wall 14 and side walls 16. Stitching 20 is provided around various edges of the walls to provide such connections and to strengthen the integrity of tea bag 10. However, it will be appreciated that the present invention is not limited to this particular shape.

As a result, tea bag 10 is formed as a small, porous, sealed bag containing tea leaves, herbal teas and/or spices, in which all of the walls are porous and completely surround the contents. The walls of tea bag 10, as is conventional, are preferably made of filter paper, which is porous to permit entry and exit of water therethrough, while preventing escape of the tea leaves therefrom. A piece of string 22 has one end attached to the top of the tea bag 10 by any suitable means, which is conventional, and a paper label 24 is attached to the opposite free end of string 22, to assist in removing tea bag 10 from hot water, while also displaying the brand or variety of tea on paper label 24.

In accordance with the present invention, a circular portion 26 at the upper end of front wall 12 has reinforced stitching 28 surrounding circular portion 26, and within circular portion 26, score lines 30 are provided. For example, score lines 30 can include a vertical diametrical score line 30a and a horizontal diametrical score line 30b. The reason for reinforced stitching 28 is to prevent tearing of the material of tea bag 10 in surrounding relation to circular portion 26 when score lines 30 are torn, as will now be discussed.

Tea bag 10 is intended to be used with an apparatus 32 having a piercing tube 34 which is intended to pierce circular portion 26 in order to supply pressurized water to tea bag 10. Apparatus 32 includes a tube holder 36 which is controlled to move up and down by a moving assembly 38. For example, in a Keurig machine, there is an upper lid section that pivots and has a piercing tube secured to the upper lid section. When the upper lid section is raised, the piercing tube moves upwardly and when it is lowered, the piercing tube moves downwardly. Conventionally, in a Keurig machine, this single portion packet is placed in the machine and the upper lid section along with the piercing tube is moved downwardly into piercing engagement with the foil lid of the single portion packet. Alternatively, moving assembly 38 can be eliminated so that the upper lid section is moved manually.

Piercing tube 34 includes an upper opening which is in fluid communication with an opening 40 in tube holder 36 and through which pressurized water is supplied from a pressurized water supply 42 to piercing tube 34, and at least one, and preferably two, small lower openings 44 at the lower end of piercing tube 34 from which the pressurized water exits piercing tube 34. Piercing tube 34 also includes a lower piercing end 46. Piercing end 46 can be a tapered sharp end, or even a tapered blunt end, which is capable of piercing tea bag 10.

However, because tea bag 10 does not have a rigid structure, as with a single portion packet for a Keurig machine, the upper end of piercing tube 34 includes a plurality of pegs 48 extending radially outward from the outer surface of piercing tube 34 and around which string 22 can be wound so as to effectively secure tea bag 10 to piercing tube 34. This also prevents tube 34 from piercing the opposite wall of tea bag 10.

With this arrangement, and with piercing tube 34 exposed, for example, when the upper lid is in a raised position, circular portion 26 of tea bag 10 is brought to the position of the lower piercing end 46 and tea bag 10 is pushed onto piercing tube 34 such that piercing tube 34 pierces circular portion 26, thereby tearing score lines 30. Thereafter, string 22 is wrapped about pegs 48 in order to hold tea bag 10 in the position shown in FIGS. 3 and 4.

Thereafter, the upper lid with piercing tube 34 is lowered, and pressurized water from pressurized water supply 42 is supplied to tube 34. The pressurized water exits small lower openings 44, which provides agitation and turbulence of the hot water entering tea bag 10, providing an improved mixing of the water with the material therein, to better extract the flavor from the tea leaves. In effect, the pressurized hot water causes a swirling movement of the water and tea leaves, which results in this turbulence and agitation. Because of the porous material of the walls of tea bag 10, the water stays a time sufficient to better extract the flavor from the tea leaves before leaving through the porous material of the walls of the tea bag 10.

Because of the reinforced stitching 28 around circular portion 26, the material of front wall 12 surrounding circular portion 26 remains intact and does not tear.

It will be appreciated that, unlike conventional usage of a tea bag, the water is supplied to the inside of tea bag 10, rather than being supplied first from outside of the tea bag. As a result, the input water functions to inflate tea bag 10, which is very different from conventional use of a tea bag where the outside water tends to collapse the tea bag, preventing the tea leaves from expanding and opening, and in fact, compressing and twisting the tea leaves, thereby restricting the steeping effect. With the present invention, the incoming water first hydrates the tea leaves and then opens up and expands the tea leaves for better steeping action.

Alternatively, piercing tube 34 and tube holder 36 can be formed as a removable unit, onto which tea bag 10 can be placed, as discussed above. Therefore, this removable unit can be inserted within a brewing machine.

It will be appreciated that, while tea bag 10 can be used with piercing tube 34, it can also be used as a conventional tea bag since the tea leaves therein will not escape through circular portion 26 while score lines 30 remain intact.

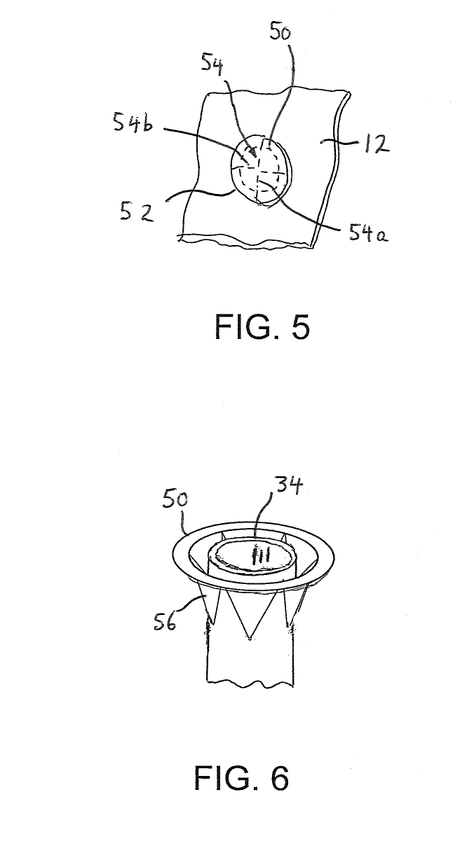

Alternatively, as shown in FIGS. 5 and 6, instead of providing score lines 30 in front wall 12 of tea bag 10, tea bag 10 can be provided with a circular opening 50 and a circular covering 52 can be adhered to tea bag 10 in covering relation to circular opening 50, with circular covering 52 having score lines 54 which can include a vertical diametrical score line 54a and a horizontal diametrical score line 54b. This prevents tearing of the material of tea bag 10 when score lines 54 are torn.

In such case, when piercing tube 34 is inserted through circular opening 50, it tears score lines 54, thereby creating triangular tabs 56 which are connected to a periphery of the circular opening 50 and which are bent down, as shown in FIG. 6, around piercing tube 34 to further hold tea bag 10 onto piercing tube 34. In such case, covering 52 can be formed of a more rigid material than the material of tea bag 10 so that tabs 56 serve as a locking mechanism which are designed to fold and engage on piercing tube 34, thereby preventing tea bag 10 from sliding or collapsing down. In such case, string 22 can be removed and need not be used in securing tea bag 10 to piercing tube 34.

Alternatively, score lines 54 in covering 52 can be eliminated, with covering 52 merely being pealed off or otherwise removed prior to use of tea bag 10 with piercing tube 34.

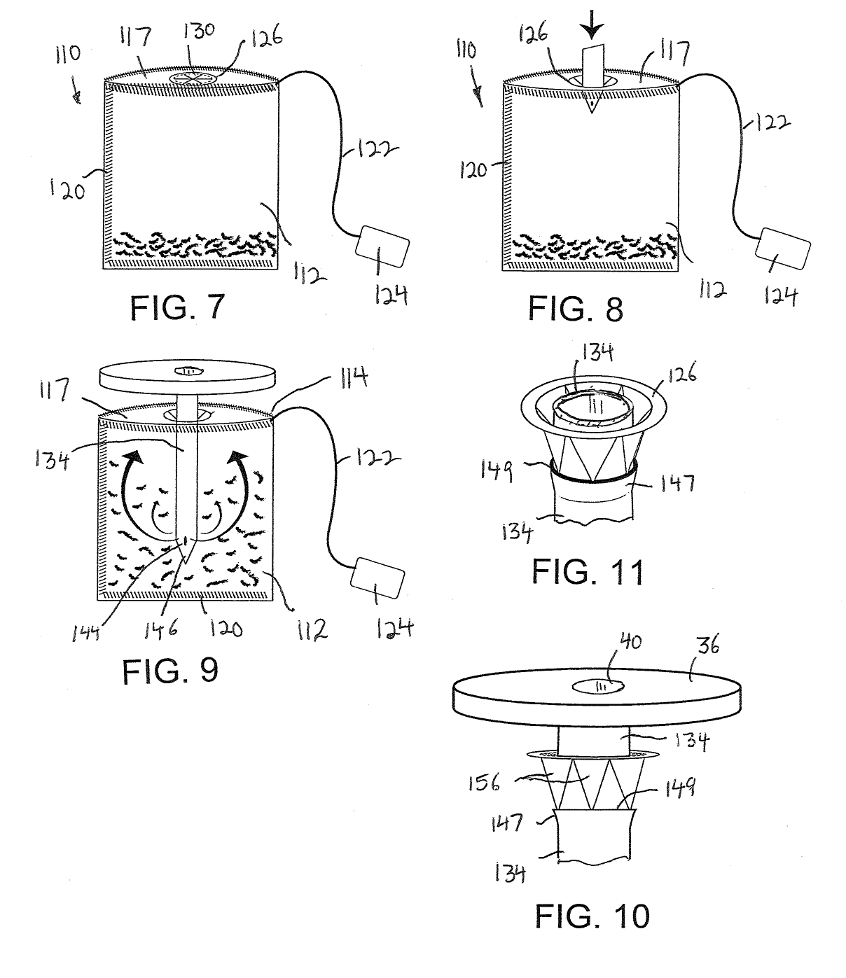

Referring now to FIGS. 7-11, a tea bag 110 according to another embodiment of the present invention will now be described.

Tea bag 110 includes a front wall 112 and rear wall 114 connected together at side edges and bottom edges thereof, and a generally oval shaped, planar top wall 117 connected to top edges of front wall 112 and rear wall 114. Stitching 120 is provided around various edges of the walls to provide such connections and to strengthen the integrity of tea bag 110.

As a result, tea bag 110 is formed as a small, porous, sealed bag containing tea leaves, herbal teas and/or spices. The walls of tea bag 110, as is conventional, are preferably made of filter paper, which is porous to permit entry and exit of water therethrough, while preventing escape of the tea leaves therefrom. A piece of string 122 has one end attached to the top of the tea bag 110 by any suitable means, which is conventional, and a paper label 124 is attached to the opposite free end of string 122, to assist in removing tea bag 110 from hot water, while also displaying the brand or variety of tea on paper label 124.

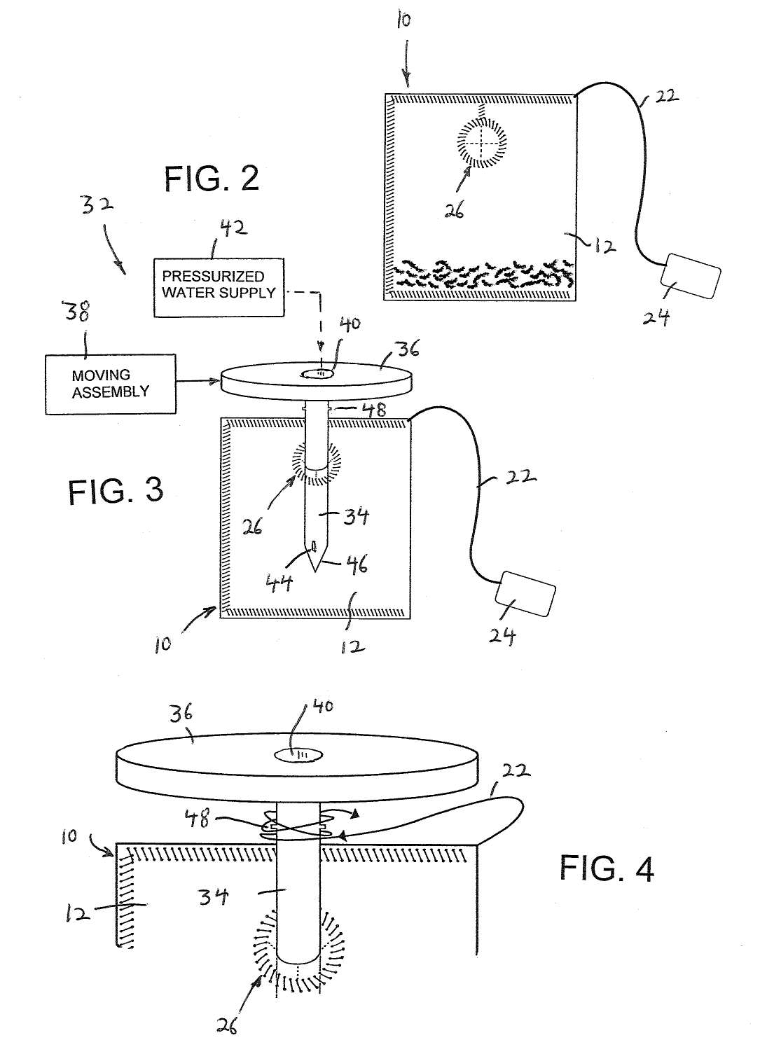

In accordance with the present invention, a circular portion 126 is formed in top wall 117. Within circular portion 126, score lines 130 are provided. For example, score lines 130 can include three diametrical score lines 130 equiangularly spaced within circular portion 126, and intersecting at the center of circular portion 126, thereby forming six triangular tabs 156 within circular portion 126. As will be discussed hereinafter, lines 130 are torn and triangular tabs 156 are bent down. In this regard, the material of top wall 117, or at least in circular portion 126, is made of a more rigid material than the porous material of the remainder of bag 110, for example, a light cardboard material or the like. Tea bag 110 is intended to be used with the apparatus 32 of FIG. 2 including tube holder 36, moving assembly 38, pressurized water supply 42 and a slightly modified piercing tube 134. As with the first embodiment, piercing tube 134 is intended to pierce circular portion 126 in order to supply pressurized water to tea bag 110.

Piercing tube 134 differs from piercing tube 34 by the elimination of pegs 48 and the addition of a flared out lip 147 spaced downwardly from the upper end of piercing tube 134, thereby creating an outer annular shoulder 149. Of course, piercing tube 134 also includes small lower openings 144 and a lower piercing end 146.

With this arrangement, and with piercing tube 134 exposed, for example, when the upper lid is in a raised position, circular portion 126 of tea bag 110 is brought to the position of the lower piercing end 146 and tea bag 110 is pushed onto piercing tube 134 such that piercing tube 134 pierces circular portion 126, thereby tearing score lines 130. Because of the rigid material of top wall 117, or at least circular portion 126 therein, the material of top wall 117 surrounding circular portion 126 remains intact and does not tear.

String 122 can remain attached to tea bag 110 or removed therefrom.

In such case, when piercing tube 134 is inserted through circular opening 126, it tears score lines 130, thereby creating triangular tabs 156 which are bent, as shown in FIG. 10, around piercing tube 134 to further hold tea bag 110 onto piercing tube 134. However, the lower free ends of tabs 156 engage flared out lip 147 to prevent further travel of tea bag 110 down piercing tube 134. Thereafter, the upper lid with piercing tube 134 is lowered, and pressurized water from pressurized water supply 42 is supplied to piercing tube 134. The pressurized water exits small lower openings 144, which provides agitation and turbulence of the hot water entering tea bag 110, providing an improved mixing of the water with the material therein, to better extract the flavor from the tea leaves. In effect, the pressurized hot water causes a swirling movement of the water and tea leaves, which results in this turbulence and agitation, while also functioning to expand the tea bag and open up the tea leaves. Because of the porous material of the walls of tea bag 110, the water stays a time sufficient to better extract the flavor from the tea leaves before leaving through the porous material of the walls of the tea bag 110.

It will be appreciated that, while tea bag 110 can be used with piercing tube 134, it can also be used as a conventional tea bag since the tea leaves therein will not escape through circular portion 126 while score lines 130 remain intact.

Alternatively, the arrangement shown in FIGS. 5 and 6 can be used with tea bag 110, instead of providing score lines 130, with covering 52 placed over circular opening 126.

Alternatively, score lines 130 in the covering can be eliminated, with the covering merely being pealed off or otherwise removed prior to use of tea bag 10 with piercing tube 34.

It will be appreciated that, while circular portions 26, 50 and 126 have been discussed regard to perforations or score lines that enable circular portions 26, 50 and 126 to be pierced, other ways of gaining access to the interior of tea bag through circular portions 26, 50 and 126 can be provided.

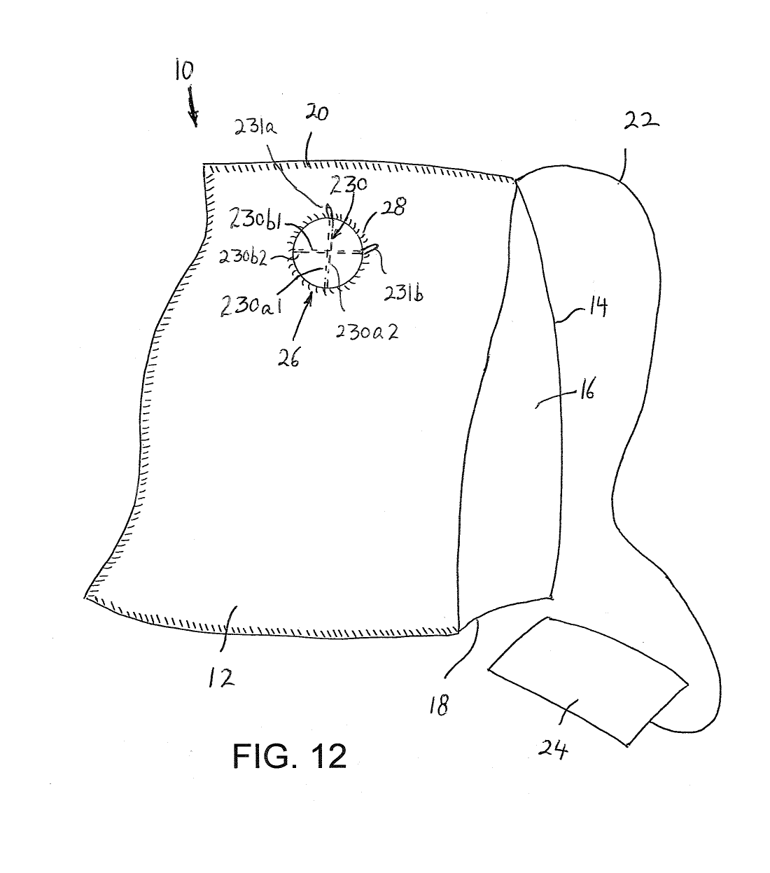

For example, as shown in FIG. 12, score lines 30a and 30b, are replaced by sets of two parallel score lines 230a1, 230a2; and 230b1, 230b2, each provided with a pull tab 231a and 231b, respectively, which enables the material between parallel score lines 230a1 and 230a2; and material between parallel score lines 230b1 and 230b2, to be torn away and removed, thereby permitting access through the circular portion 26. As such, circular portion 26 is not piercable, but rather, then becomes accessible to tube 34.

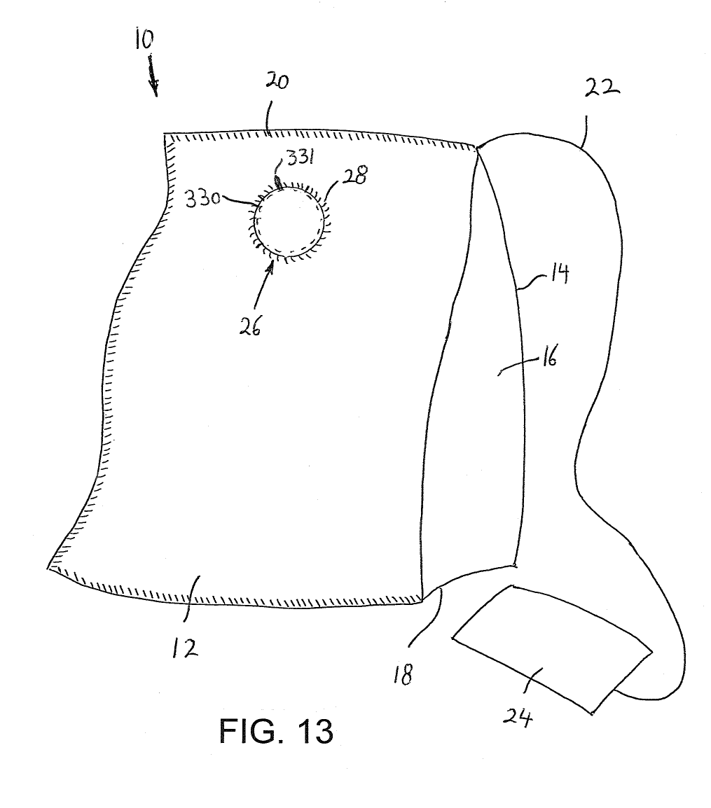

As another alternative, as shown in FIG. 13, an outer circular score line 330 can be provided at the outer periphery of circular portion 26, and has a pull tab 331 by which circular school line 330 can be torn so that the area within can be removed, thereby making circular portion 26 accessible to tube 34.

It will be appreciated that the same score lines shown in FIGS. 12 and 13 can also be provided with a covering, such as covering 50 shown in FIG. 5.

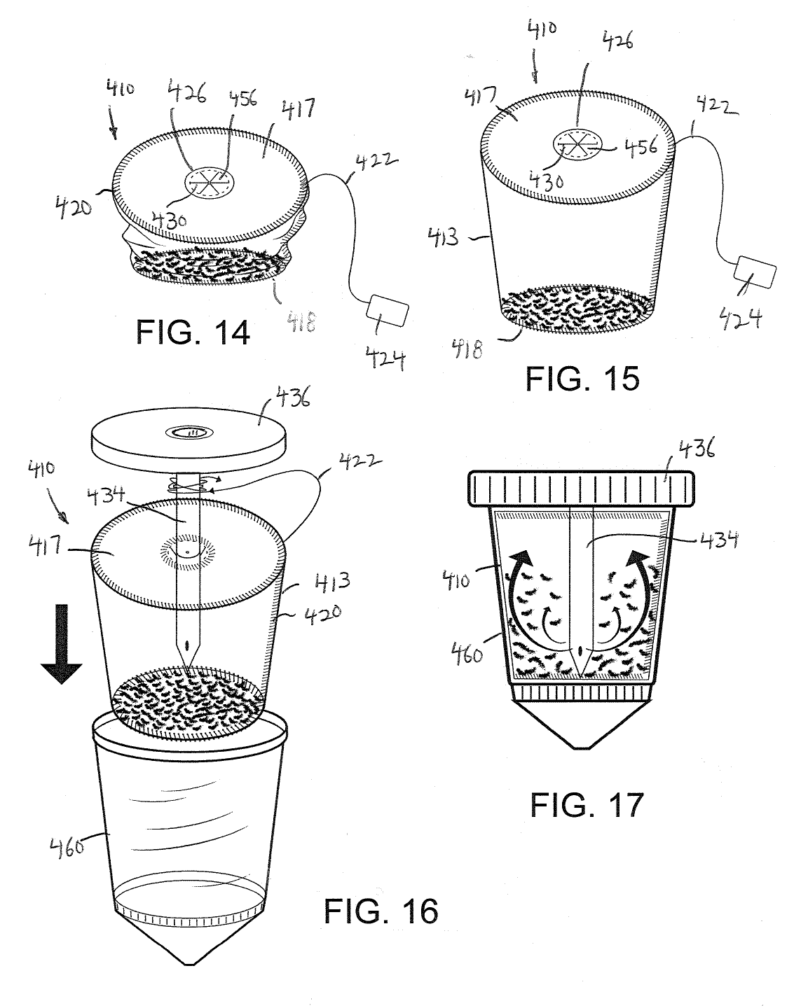

Referring now to FIGS. 14-17, there is shown a tea bag 410 according to a fourth embodiment of the present invention for use with a brewable beverage making cup adaptor for a cartridge type coffee making machine according to applicant's earlier filed U.S. patent application Ser. No. 14/140,189 filed on Dec. 24, 2013, the entire disclosure of which is incorporated herein by reference.

Specifically, tea bag 410 includes a frusto-conical side wall 413 that is closed at its upper edge by a circular top wall 417 and is closed at its bottom edge by a circular bottom wall 418 of a smaller diameter than top wall 417. Stitching 420 is provided around various edges of the walls to provide such connections and to strengthen the integrity of tea bag 410.

As a result, tea bag 410 is formed as a small, porous, sealed bag containing tea leaves, herbal teas and/or spices. At least side walls 413 and bottom wall 418, as is conventional, are preferably made of filter paper, which is porous to permit entry and exit of water therethrough, while preventing escape of the tea leaves therefrom.

A piece of string 422 has one end attached to the top of the tea bag 410 by any suitable means, which is conventional, and a paper label 424 is attached to the opposite free end of string 422, to assist in removing tea bag 410 from hot water, while also displaying the brand or variety of tea on paper label 424.

In accordance with the present invention, a circular portion 426 is formed in top wall 417. Within circular portion 426, score lines 430 are provided. For example, score lines 430 can include three diametrical score lines 430 equiangularly spaced within circular portion 426, and intersecting at the center of circular portion 426, thereby forming six triangular tabs 456 within circular portion 426. In the manner as discussed above, lines 430 are torn and triangular tabs 456 are bent down. In this regard, the material of top wall 417, or at least in circular portion 426, is made of a more rigid material than the porous material of the remainder of bag 410, for example, a light cardboard material or the like.

Tea bag 410 is intended to be used with a brewable beverage making cup adaptor 460 for a cartridge type coffee making machine according to applicant's earlier filed U.S. patent application Ser. No. 14/140,189 filed on Dec. 24, 2013. Preferably, cup adapter 460 has the same shape and dimensions as tea bag 410 is expanded state shown in FIG. 15. Thus, piercing tube 434 is inserted through circular portion 336 in the manner previously described in FIGS. 3 and 4, with string 422 secured around pegs 448. Then, tube holder 436 can be secured to the top of cup adapter 460 with piercing tube 334 piercing circular portion 426. As a result, tea bag 410 is positioned within cup adapter 460 and assumes the shape of cup adapter 460. Thereafter, pressurized water is supplied to tea bag 410. The pressurized water tends to expand tea bag 410 and causes agitation and turbulence of the water and tea leaves within tea bag 410, resulting in a swirling action under pressure. This functions to moisten and open up the tea leaves for better steeping action. After a certain time period, an opening (not shown) in the bottom of cup adapter 460 is opened so that the brewed tea exits through porous bottom wall 418 and the opening in the bottom of cup adapter 460.

It will be appreciated that, with this arrangement, tea bag 410 is pushed onto piercing tube 434 such that piercing tube 434 pierces circular portion 426, thereby tearing score lines 430. Because of the rigid material of top wall 417, or at least circular portion 426 therein, the material of top wall 417 surrounding circular portion 426 remains intact and does not tear.

It will be appreciated that, while tea bag 410 can be used with piercing tube 434, it can also be used as a conventional tea bag since the tea leaves therein will not escape through circular portion 426 while score lines 430 remain intact.

Alternatively, the arrangement shown in FIGS. 5 and 6 can be used with tea bag 410, instead of providing score lines 430, with a covering having the score lines placed over circular opening 426.

Alternatively, the score lines in the covering can be eliminated, with the covering merely being pealed off or otherwise removed prior to use of tea bag 410 with piercing tube 434.

Having described specific preferred embodiments of the invention with reference to the accompanying drawings, it will be appreciated that the present invention is not limited to those precise embodiments and that various changes and modifications can be effected therein by one of ordinary skill in the art without departing from the scope or spirit of the invention as defined by the appended claims.

What is claimed is:

1. A porous bag for brewing a brewable substance held therein, comprising:
an enclosure bag including walls made from a porous material, with the brewable substance held in the enclosure bag; and
an accessible opening in one wall of the enclosure bag for receiving a liquid supply tube therein for supplying liquid to the enclosure bag, the accessible opening preventing the brewable substance from escaping so that the porous bag can be used as a steeping bag in a liquid, while also permitting access to the opening to permit supply of the liquid therein from the liquid supply tube inserted therethrough.

2. A porous bag according to claim 1, wherein said accessible opening includes at least one score line in said one wall.

3. A porous bag according to claim 2, further comprising a reinforcing arrangement around the accessible opening for preventing tearing of said one wall in an area surrounding the accessible opening when the score lines are torn.

4. A porous bag according to claim 2, wherein the at least one score line divides the accessible opening into a plurality of tabs which are connected at a periphery of the accessible opening, and which are connected to each other by a plurality of score lines.

5. A porous bag according to claim 4, wherein the tabs each have a triangular configuration.

6. A porous bag according to claim 2, wherein the at least one score line includes a circumferential score line adapted to be torn to remove the material of said one wall within said circumferential score line to expose said accessible opening.

7. A porous bag according to claim 2, wherein the at least one score line includes at least one set of parallel score lines adapted to be torn to remove the material of said one wall between each set of parallel score lines, to expose said accessible opening.

8. A porous bag according to claim 2, wherein the at least one score line is adapted to be torn by piercing.

9. A porous bag according to claim 1, wherein the accessible opening is formed of a material that is more rigid than the porous material of the walls of the bag.

10. A porous bag according to claim 1, wherein the enclosure bag includes a top wall of a material that is more rigid than the porous material of the walls of the bag, and the accessible opening is formed in the top wall.

11. A porous bag according to claim 1, further including a string having one end attached to at least one said wall.

12. A porous bag according to claim 1, further comprising a covering secured to said one wall in covering relation to the accessible opening which prevents the brewable substance from escaping so that the porous bag can be used as a steeping bag in a liquid, while also permitting access to the accessible opening to permit supply of the liquid therein from the liquid supply tube inserted therethrough.

13. A porous bag according to claim 12, wherein said covering includes at least one score line in said one wall.

14. A porous bag according to claim 13, wherein the at least one score line divides the covering into a plurality of tabs which are connected at a periphery of the covering, and which are connected to each other by a plurality of score lines.

15. A porous bag according to claim 14, wherein the tabs each have a triangular configuration.

16. A porous bag according to claim 13, wherein the at least one score line includes a circumferential score line adapted to be torn to remove material of said covering within said circumferential score line to expose said accessible opening.

17. A porous bag according to claim 13, wherein the at least one score line includes at least one set of parallel score lines adapted to be torn to remove material of said covering between each set of parallel score lines, to expose said accessible opening.

18. A porous bag according to claim 12, wherein the covering is formed of a material that is more rigid than the porous material of the walls of the bag.

19. A porous bag according to claim 1, further comprising a covering removably secured to said one wall in covering relation to the accessible opening.

20. A porous bag according to claim 1, wherein tea bag has a frusto-conical side wall for fitting within a frusto-conical cup adapter of similar dimensions for brewing.
